(19) United States
(12) Patent Application Publication
(10) Pub. No.: US 2026/0273865 A1
(43) Pub. Date: Sep. 17, 2026

(54) DIFFERENTIALLY DRIVEN EXTRUSION SYSTEM FOR ADDITIVE MANUFACTURING

(71) Applicant: Behnam Salemi, San Diego, CA (US)

(72) Inventor: Sherwin SALEMI, San Diego, CA (US)

(73) Assignee: Behnam Salemi, San Diego, CA (US)

(21) Appl. No.: 19/565,951

(22) Filed: Mar. 13, 2026

Related U.S. Application Data
(60) Provisional application No. 63/772,575, filed on Mar. 16, 2025.

(51) Int. Cl. B29C 64/393; B29C 64/236; B33Y 30/00; B33Y 50/02

(52) U.S. Cl. CPC B29C 64/393; B29C 64/236; B33Y 30/00; B33Y 50/02

(57) ABSTRACT

A differential belt-driven additive manufacturing system is disclosed in which multiple stationary motors cooperatively generate both translational motion and extrudent extrusion through a shared kinematic architecture. Motor rotations are resolved via linear differential relationships such that translation corresponds to the difference of motor displacements and extrusion corresponds to their sum. The architecture reduces moving mass by eliminating a dedicated extrusion motor on the print head while maintaining direct-drive responsiveness. Experimental results demonstrate substantially higher achievable accelerations compared to conventional systems, with minimal degradation under increased extrusion loads.

### CROSS REFERENCE TO RELATED APPLICATIONS

This application claims priority to and the benefit of the filing date of provisional U.S. Patent Application No. 63/772,575, entitled “DIFFERENTIALLY DRIVEN EXTRUSION SYSTEM FOR HIGH SPEED FDM 3D PRINTING” and filed on Mar. 16, 2025, the entire contents of which is hereby expressly incorporated herein by reference.

### TECHNICAL FIELD

Implementations of the present disclosure relate to additive manufacturing motion systems, and specifically to differential belt-driven architectures that resolve coordinated translation and extrusion of extrudent from shared stationary motor actuation.

### BACKGROUND

Additive manufacturing systems, particularly fused deposition modeling (FDM) printers, commonly rely on independent drive mechanisms for translational motion and filament extrusion. In many conventional architectures, X-Y motion is achieved using belt-driven gantries such as Cartesian or CoreXY configurations, while extrusion is controlled by a separate motor mounted directly on the print head (direct drive) or remotely mounted with a Bowden tube arrangement. Although direct-drive systems offer responsive filament control, they increase the moving mass of the print head, limiting acceleration and reducing achievable print speeds. Conversely, Bowden-style systems reduce moving mass but introduce compliance, hysteresis, and reduced extrusion precision due to filament compression and delay.

As print speeds and acceleration demands have increased, the tradeoff between moving mass and extrusion responsiveness has become more pronounced. High-speed printing requires lightweight moving assemblies to reduce inertia and vibration, yet accurate material deposition requires precise, synchronized control of filament advancement and nozzle position. Traditional architectures treat translation and extrusion as mechanically independent subsystems, which can introduce synchronization complexity and limit dynamic performance. Accordingly, there exists a need for an additive manufacturing architecture that reduces moving mass while preserving direct-drive extrusion responsiveness, and that integrates translation and extrusion in a coordinated mechanical system capable of high-speed, high-precision operation.

### SUMMARY

In accord with one general aspect, described herein is a system having a processor and a memory in communication with the processor, where the memory includes executable instructions that, when executed by the processor, cause the system to perform multiple functions. The system can also include an additive manufacturing system having an extrusion module movable relative to a frame, the system including a plurality of stationary motors that jointly control translation and extrusion through a differential belt mechanism. These functions may include receiving a motion command, wherein the motion command specifies a commanded translational displacement of the extrusion module and a commanded extrusion displacement of filament, and computing, based on a differential kinematic transformation, a plurality of motor actuation values corresponding to the commanded translational displacement and the commanded extrusion displacement, each motor actuation value being a function of both commanded displacements. The functions can further include driving the plurality of stationary motors according to the computed motor actuation values, translating the extrusion module along an axis in response to a differential component of motion generated by the stationary motors, and extruding or retracting filament in response to a rotational component of motion generated by the stationary motors.

In accord with another general aspect the method described herein may involve multiple steps. These steps may be for controlling an additive manufacturing system having an extrusion module movable relative to a frame, the system including a plurality of stationary motors that jointly control translation and extrusion through a differential belt mechanism. These steps may include receiving a motion command, wherein the motion command specifies a commanded translational displacement of the extrusion module and a commanded extrusion displacement of filament, and computing, based on a differential kinematic transformation, a plurality of motor actuation values corresponding to the commanded translational displacement and the commanded extrusion displacement, each motor actuation value being a step of both commanded displacements. The steps can further include driving the plurality of stationary motors according to the computed motor actuation values, translating the extrusion module along an axis in response to a differential component of motion generated by the stationary motors, and extruding or retracting filament in response to a rotational component of motion generated by the stationary motors.

In accord with yet another general aspect, the instant disclosure describes a non-transitory computer readable medium on which are stored instructions that when executed cause a programmable device to perform multiple functions. These functions may include receiving a motion command, wherein the motion command specifies a commanded translational displacement of the extrusion module and a commanded extrusion displacement of filament, and computing, based on a differential kinematic transformation, a plurality of motor actuation values corresponding to the commanded translational displacement and the commanded extrusion displacement, each motor actuation value being a function of both commanded displacements. The functions can further include driving the plurality of stationary motors according to the computed motor actuation values, translating the extrusion module along an axis in response to a differential component of motion generated by the stationary motors, and extruding or retracting filament in response to a rotational component of motion generated by the stationary motors.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a flow diagram for an example method for controlling an additive manufacturing system.

FIG. 2A depicts an example architecture in which the method of FIG. 1 of the present implementations may operate.

FIG. 2B is a block diagram showing an example system of the architecture of FIG. 2A along with its corresponding subsystems.

FIG. 3A illustrates a cutaway view of a differentially driven extrusion and translation system of the present implementations.

FIG. 3B is a conceptual representation of the system shown in FIG. 3A.

FIG. 4 show additive manufacturing apparatus incorporating the differential extrusion and X-axis translation system described in FIGS. 3A and 3B.

FIG. 5 illustrates multiple views of an alternative implementation of the differential extrusion and translation system of FIGS. 3A, 3B, and 4, in which both stationary motors are positioned on a single side of the support structure rather than at opposite ends of the X-axis.

FIG. 6 is a conceptual schematic illustrating an implementation in which both X-axis and Y-axis translation are controlled by motors positioned at the corners of the support structure.

FIG. 7 illustrates an implementation of the differential motion architecture as in FIG. 6 but implemented with four motors positioned at the corners of the support structure, two on each side.

FIG. 8 is an overhead conceptual representation of the multi-motor differential architecture illustrated in FIG. 7.

FIG. 9 is a block diagram showing an example software architecture, various portions of which may be used in conjunction with various hardware architectures herein described, which may implement any of the described features.

FIG. 10 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

### Technical Problem

The implementations herein can be directed to a performance limitation in high-speed FDM 3D printing: the competing requirements of extrusion precision and low printhead mass. In conventional direct-drive extrusion systems, the extruder motor is mounted on the moving printhead, which provides accurate filament control, reliable retraction, and compatibility with a wide range of materials. However, this configuration significantly increases printhead mass, which limits acceleration, increases vibration, and constrains achievable print speed and motion stability.

Existing attempts to reduce printhead mass introduce their own technical drawbacks. Bowden systems relocate the extruder motor off the printhead, reducing moving mass but introducing filament path friction, elasticity, and delayed response, which degrade extrusion accuracy and material handling reliability. Lightweight or “pancake” stepper motors provide only partial mass reduction and often lack sufficient torque or flow capacity for high-speed printing.

Accordingly, the technical problem addressed by the implementations is how to achieve high-speed, high-acceleration printhead motion while retaining the control fidelity and material versatility of a direct-drive extrusion system. More specifically, the challenge is to remove the heavy extrusion motor from the moving printhead without sacrificing extrusion responsiveness, torque availability, or coordinated control between motion and material deposition. The implementations target this structural and kinematic tradeoff by addressing the mechanical coupling between extrusion actuation and printhead motion, which conventional architectures treat as separate or mutually limiting subsystems.

### Technical Solution

The implementations herein provide a differentially driven extrusion system that mechanically couples printhead translation and filament extrusion through a shared belt-driven actuation architecture. Multiple stationary motors positioned off the printhead each drive a dedicated closed-loop belt routed along the printer frame and engaged with a pulley mounted on the extrusion shaft of the movable printhead. Because the belts act on the extrusion pulley from different paths, their combined motion can produce both rotational and translational outputs. Specifically, the extrusion shaft rotates to drive filament when motor motions combine, while lateral force generated by differential belt motion translates the printhead along the axis. Thus, both positioning and extrusion are derived from linear combinations of the same motor inputs. This differential mechanism enables a direct-drive extrusion configuration without mounting an extrusion motor on the printhead, reducing moving mass while maintaining precise extrusion control.

A software implementation provides a kinematic transformation layer that maps desired extrusion and translation commands into coordinated motor actuation using a differential control model. In a motion command can be represented as a task vector u=[ΔX, ΔE]^{T}, where ΔX is commanded printhead displacement and ΔE is commanded extrusion displacement. The control system applies a transformation matrix K to produce a motor actuation vector θ=[Δθₐ, Δθ_{b}]^{T}, such that θ=K·u, where each motor displacement is a linear combination of translation and extrusion components. The inverse mapping defines system outputs as a differential response tensor y=D·θ, resolving shared actuator inputs into coordinated mechanical effects. Firmware or post-processing modules can implement this transformation, converting conventional motion instructions into synchronized motor commands that simultaneously generate extrusion torque and translational force.

As used herein, the term “extrudent” refers to any material, substance, composition, or matter configured to be advanced, dispensed, deposited, or otherwise emitted from an extrusion mechanism of an additive manufacturing device. An extrudent may include solid, semi-solid, viscous, particulate, granular, or composite materials capable of being driven through or from an extrusion system by mechanical force, pressure, or controlled displacement. Extrudents may include, for example and without limitation, thermoplastic filaments, reinforced filaments containing fibers or fillers, elastomeric materials, thermosetting polymers, adhesives, sealants, pastes, gels, slurries, powders, loose particulates, granular feedstocks, metal-filled materials, ceramic-filled materials, or combinations thereof. In some implementations, the extrudent may be supplied in filament form, pellet form, powder form, or as a viscous or flowable medium stored in a cartridge, hopper, syringe, or other supply mechanism. The term “extrudent” is used broadly and is not limited to materials that are melted or liquefied prior to deposition. Rather, the term encompasses any material that can be conveyed or expelled through an extrusion device under controlled actuation. Accordingly, the extrudent may include materials deposited in molten, softened, viscous, particulate, or otherwise flowable states, as well as materials that are compacted or consolidated during extrusion. Unless otherwise specified, the term “extrudent” is intended to encompass any matter that can be delivered through the extrusion mechanism of the additive manufacturing apparatus described herein.

As used herein, the term “filament” can be used as an examplary general extrudent and can refer to an elongated, continuous, or semi-continuous feedstock material configured to be mechanically advanced through an extrusion mechanism of an additive manufacturing device. A filament typically has a substantially uniform cross-sectional profile along its length and is supplied in a form that can be driven by an extrusion drive element, such as a gear, pulley, or feed mechanism, toward an extrusion outlet or deposition nozzle. Filaments may include thermoplastic materials such as polylactic acid (PLA), acrylonitrile butadiene styrene (ABS), polyethylene terephthalate glycol (PETG), nylon, polycarbonate, or other polymer-based materials. In some implementations, filaments may include composite or reinforced materials incorporating fibers, particles, or fillers, such as carbon fiber, glass fiber, metal powder, ceramic particles, or similar reinforcement additives. Filaments may also include flexible polymers, elastomeric materials, or specialty engineering materials designed for specific mechanical, thermal, or chemical properties. The filament may be supplied as a continuous strand wound on a spool or stored in another feed arrangement. The cross-sectional shape of the filament may be circular, elliptical, rectangular, or otherwise shaped, although circular cross-sections are common in many implementations. In some implementations, the filament can be driven by rotation of an extruder shaft or filament engagement mechanism and may be softened, melted, or otherwise conditioned prior to deposition through a nozzle. Unless otherwise specified, the term “filament” refers to any elongated feedstock material suitable for controlled advancement through an extrusion system to form deposited layers in an additive manufacturing process.

As used herein, the terms “high-speed fused deposition modeling,” “FDM 3D printing,” and the like can refer to an additive manufacturing process in which an extrudable material, such as thermoplastic filament or another extrudent, is heated or otherwise conditioned and deposited through an extrusion mechanism while the deposition head and/or build platform move relative to one another to form a three-dimensional object layer by layer. In high-speed FDM implementations, the motion system and extrusion system are configured to operate at elevated printhead velocities and accelerations relative to conventional FDM systems while maintaining controlled material deposition and dimensional accuracy. High-speed FDM printing may involve coordinated control of translation and extrusion, high-flow nozzles, rapid acceleration and deceleration profiles, and motion architectures designed to reduce moving mass or improve torque utilization. In some implementations, printhead speeds may exceed hundreds of millimeters per second and acceleration values may exceed tens of thousands of millimeters per second squared, although the term is not necessarily limited to any specific numerical threshold. The term is used herein as an example category of additive manufacturing processes that may benefit from the disclosed motion and extrusion architectures. However, the systems and methods described herein are not limited to fused deposition modeling and may be applied to other extrusion-based or material-deposition additive manufacturing techniques.

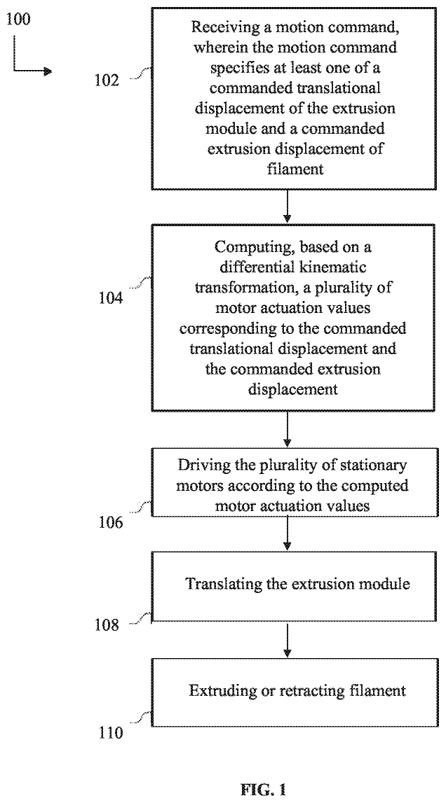

FIG. 1 is a flow diagram for an example method 100 for controlling an additive manufacturing system. The method 100 can include receiving a motion command, wherein the motion command specifies at least one of a commanded translational displacement of the extrusion module and a commanded extrusion displacement of filament (Step 102). This receiving process can correspond to the intake of a motion command that defines the intended physical behavior of the additive manufacturing system over a discrete motion segment. At this stage, the implementations can receive a structured instruction specifying at least one of two coordinated objectives, translational displacement of the extrusion module along the X-axis or extrusion displacement of filament. These commands may originate from parsed toolpath data (e.g., G-code) and represent the desired geometric and material outcome of the next motion interval. The motion command can be defined in task space rather than motor space. It specifies what the system must accomplish physically, not how individual motors must rotate. The commanded translational displacement ΔX represents the desired positional change of the extrusion module relative to the support frame. The commanded extrusion displacement ΔE represents the intended advancement or retraction of filament through the hotend during the same interval. The command may additionally include dynamic parameters such as feed rate, acceleration limits, and jerk constraints. These parameters define not only the magnitude of displacement but also how the motion should be executed temporally. For example, ΔX and ΔE may be accompanied by a target velocity profile that ensures deposition quality and mechanical stability. The receiving process can thereby establish translation and extrusion as coordinated components of a unified motion state. Rather than treating extrusion as a separate subsystem, the received command encodes both displacement components as part of a single commanded motion vector. This unified representation can provide for differential resolution in later steps, as translation and extrusion can be produced by shared motor actuation.

In an exemplary implementation, this receiving process can define the intake of a task-space motion vector representing commanded physical displacement. The received motion command can be formalized as

$$u = [ \begin{matrix}Δ X \\ Δ E\end{matrix} ] ,$$

where ΔX∈ [symbol] represents commanded translational displacement along the X-axis, and ΔE∈ [symbol] represents commanded extrusion displacement. This vector resides in a 2-dimensional task space T, where each axis corresponds to an independent physical output of the system. In some implementations, the command may include a temporal constraint vector:

$$c = [ \begin{matrix}{v}_{target} \\ {a}_{max} \\ {j}_{max}\end{matrix} ] ,$$

where velocity, acceleration, and jerk limits define admissible time parameterization. The task vector u defines the desired endpoint displacement over a motion interval τ. Formally:

$$u = {\int }_{{t}_{0}}^{{t}_{1}} \dot{u} ( t ) dt ,$$

where \dot{u}(t) is the instantaneous task velocity vector.

At this stage, no motor-space quantities are necessarily computed. The implementations can remain in output coordinate representation. The task vector does not necessarily encode belt motion, pulley rotation, or motor angles. It can define the desired physical displacement in output space. In differential kinematic architecture, the task space is coupled; however, at the receiving step the command vector is treated as independent axes awaiting transformation. Thus, the receiving process can produce a structured task-space tensor: [symbol] ={u, c}, which can serve as the input state for differential kinematic mapping performed downstream.

The method 100 can include computing, based on a differential kinematic transformation, a plurality of motor actuation values corresponding to the commanded translational displacement and the commanded extrusion displacement, each motor actuation value being a function of both commanded displacements (Step 104). During this computing process, the implementations can perform the differential kinematic transformation that converts the commanded task-space motion into coordinated motor-space actuation values. Here, the implementations have already received a motion command specifying a translational displacement ΔX of the extrusion module and an extrusion displacement ΔE of filament. These quantities describe the intended physical outcome in output space. However, because the disclosed architecture can utilize a belt-driven differential mechanism, neither translation nor extrusion is independently driven by a singular, dedicated motor. Instead, both physical outputs arise from coordinated angular displacements of a plurality of stationary motors. The purpose of this process can therefore be to compute the required motor angular displacements that, when executed, will produce the commanded ΔX and ΔE simultaneously.

The implementations can obey forward differential relationships of the form ΔX=(α/2)(Δθₐ-Δθ_{b}) and ΔE=(α/(2β))(Δθₐ+Δθ_{b}), where Δθₐ and Δθ_{b} represent angular displacements of Motor A and Motor B, a corresponds to the circumference of the motor pulleys, and B corresponds to the circumference of the extrusion pulley coupled to the extrusion shaft. These equations can reflect the mechanical reality that translation is generated by the difference of motor rotations, while extrusion is generated by their sum. Because the task-space command is known and the motor rotations are unknown, this computation can apply the inverse mapping of this differential system. Solving the system of equations yields Δθₐ=(1/α)(ΔX+βΔE) and Δθ_{b}=(1/α(−ΔX+βΔE). These expressions can define the precise angular displacements required of each motor. This transformation can be expressed compactly in vector form. The commanded task vector u=[ΔX, ΔE] T is mapped into motor space via θ=K·u, where θ=[Δθₐ, Δθ_{b}]^{T} and K=(1/α)[[1, β], [−1, β]]. Conversely, the forward mapping may be written u=D·θ, where D=[[α/2, −α/2], [α/(2β), α/(2β)]]. These matrices can encode pulley geometry and belt routing topology. Importantly, the mapping is linear, meaning that translation and extrusion contributions superimpose algebraically. The antisymmetric component of 0 produces translation, while the symmetric component produces extrusion.

This computation resolves a two-dimensional physical objective into a two-dimensional motor actuation vector using geometry-dependent coefficients. If ΔE=0, the computed motor values are equal in magnitude and opposite in sign, producing pure translation. If ΔX=0, the motors rotate equally in the same direction, producing pure extrusion. When both values are nonzero, the resulting motor displacements combine symmetric and antisymmetric components to generate simultaneous translation and extrusion. Thereby, this computation transforms physical intent into actuator-specific commands in a mathematically determined manner consistent with the differential architecture.

The method 100 can include driving the plurality of stationary motors according to the computed motor actuation values (Step 106). During this driving process, the implementations translate the computed motor angular displacements into coordinated physical actuation of the stationary motors. Having determined Δθₐ and AOb from the differential transformation, the system can now execute these angular displacements over time in a manner that preserves the proportional relationships necessary to produce the intended ΔX and ΔE. Because translation and extrusion arise from linear combinations of motor motion, any deviation in timing or magnitude between the two motors would alter the physical result. The implementations therefore can include synchronized temporal execution of the motor trajectories.

Motor motion is time-parameterized such that θ(t)=[θₐ(t), θ_{b}(t)]^{T} satisfies θₐ(t₁)-θₐ (t₀)=Δθₐ and θ_{b}(t₁)−θ_{b}(t₀)=Δθ_{b}. The instantaneous motor velocities are given by \dot{x}θ(t)=[\dot{x}θₐ(t), \dot{x}θ_{b}(t)]^{T}, and accelerations by \dot{x}θ(t). These trajectories can be generated subject to constraints such as |\dot{x}θᵢ|≤ω_max and |\ddot{x}θᵢ|≤a_max, providing that mechanical limits are respected. The controller can provide that both motors complete their respective displacements over the same time interval, thereby preserving the proportional combination required by the differential mapping.

As an example, if one motor were to accelerate more rapidly or complete its motion earlier than the other, the resulting ΔX and ΔE would deviate from the commanded values because ΔX depends on (Δθₐ-Δθ_{b}) and ΔE depends on (Δθₐ+Δθ_{b}). Thus, synchronized execution can be provided. The implementations can generate trapezoidal or S-curve velocity profiles for each motor such that the integrated angular displacement equals the computed 40 value. The time-domain behavior of translation and extrusion then becomes X(t)=(α/2)(θₐ (t)-θ_{b}(t)) and E(t)=(α/(2))(θₐ(t)+θ_{b}(t)), providing that translation and extrusion evolve continuously and proportionally during execution. In some implementations, this driving process can enforce dynamic realization of θ(t) such that

$${\int }_{{t}_{0}}^{{t}_{1}} \dot{x} θ ( t ) \dot{d} t = θ .$$

This converts static displacement vectors into physically executable trajectories. The motor control signals, whether step pulses or equivalent, can be generated to match these time-parameterized profiles. Thereby, this driving process can implement the dynamic embodiment of the differential transformation, providing that motor-space commands are executed in synchronized time so that the resulting physical outputs remain faithful to the intended ΔX and ΔE.

The method 100 can include translating the extrusion module along an axis in response to a differential component of motion generated by the stationary motors (Step 108). During this translation process, the implementations can execute the physical resolution of translational motion resulting from the executed motor trajectories. Once 0a(t) and Ob(t) are driven, the belts can apply forces to the extrusion pulley mounted on the extrusion module. Because the pulley is free both to rotate and to translate along the X-axis, the mechanical effect of motor rotation is decomposed into torque and lateral force components. The translational component arises from the antisymmetric combination of motor rotations. The displacement along the X-axis can be governed by the relationship ΔX=(α/2)(Δθₐ-Δθ_{b}). In the time domain, this becomes X(t)=(α/2)(θₐ(t)−θ_{b}(t)). When the motors rotate in opposite directions with equal magnitude, (Δθₐ-Δθ_{b}) is maximized while (Δθₐ+Δθ_{b}) is minimized, producing pure translation without extrusion. The belts generate lateral force on opposite sides of the extrusion pulley, pulling the module along the X-axis.

According to some implementations, translation can correspond to projection of the motor vector θ onto the antisymmetric basis vector [1, −1]^{T}. That is, ΔX is proportional to Vaifre, where v_{diff}=[1, −1]. This reveals that translation is not independently actuated but is instead the differential component of motor motion. Thereby, this translation includes the emergence of translational motion from coordinated motor execution. The translation is not commanded separately at the mechanical level; it arises naturally from the computed motor displacements. The linear mapping provides that translation scales proportionally with the difference in motor rotations. By prior structuring the motor actuation according to upstream processes, the implementations provide that translation of the extrusion module is produced as commanded.

The method 100 can include extruding or retracting filament in response to a rotational component of motion generated by the stationary motors (Step 110). This extrusion or retraction process can include the physical resolution of extrusion or retraction resulting from motor execution. Whereas translation arises from the antisymmetric difference of motor rotations, extrusion arises from their symmetric sum. The governing relationship is ΔE=(α/(2β))(Δθₐ₊Δθ_{b}), and in time-domain form E(t)=(α/(2))(θₐ (t)+θ_{b}(t)). When both motors rotate in the same direction with equal magnitude, the sum (Δθₐ+Δθ_{b}) can be maximized while their difference approaches zero, producing pure rotation of the extrusion shaft without translation.

Mechanically, cooperative belt motion applies net torque to the extrusion pulley. The pulley rotates about its axis, driving the extrusion shaft and advancing or retracting filament. The magnitude of extrusion displacement can be scaled by α/(2β), reflecting the relationship between motor pulley circumference and extrusion pulley circumference.

In some implementations, extrusion corresponds to projection of θ onto the symmetric basis vector vₛᵤₘ=[1, 1]^{T}. Thus, ΔE is proportional to vₛᵤₘ_{^{T}}_{θ}. Translation and extrusion therefore form orthogonal components of motor-space motion: one determined by difference, the other by sum. This orthogonality is encoded directly in the forward mapping matrix D. When both symmetric and antisymmetric components are present, extrusion and translation occur simultaneously. The linearity of the system provides superposition: combined motion can be simply the algebraic sum of the two components. Thereby, extrusion or retraction can represent the physical realization of the symmetric component of motor rotation as filament advancement or retraction. Together, the combined translation and net extrusion demonstrate that the differential mechanism decomposes motor-space motion into translation and extrusion via orthogonal linear combinations, faithfully implementing the equations ΔX=(α/2)(Δθₐ-Δθ_{b}) and ΔE=(α/(2B))(Δθₐ₊Δθ_{b}).

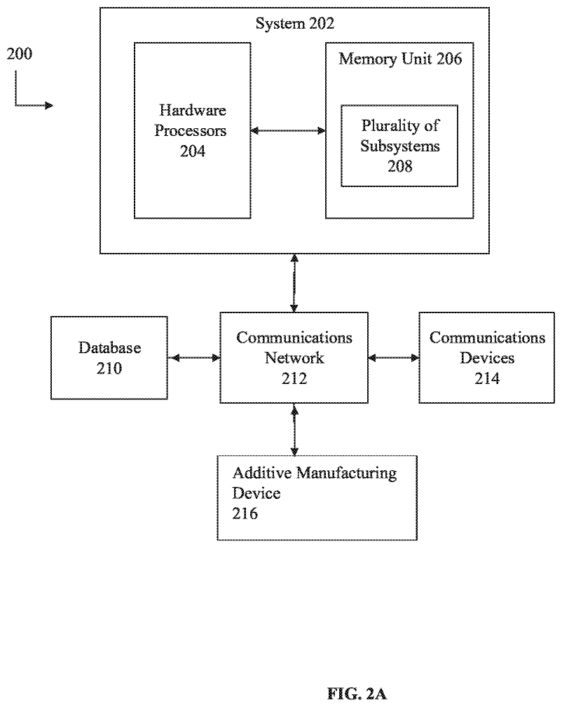

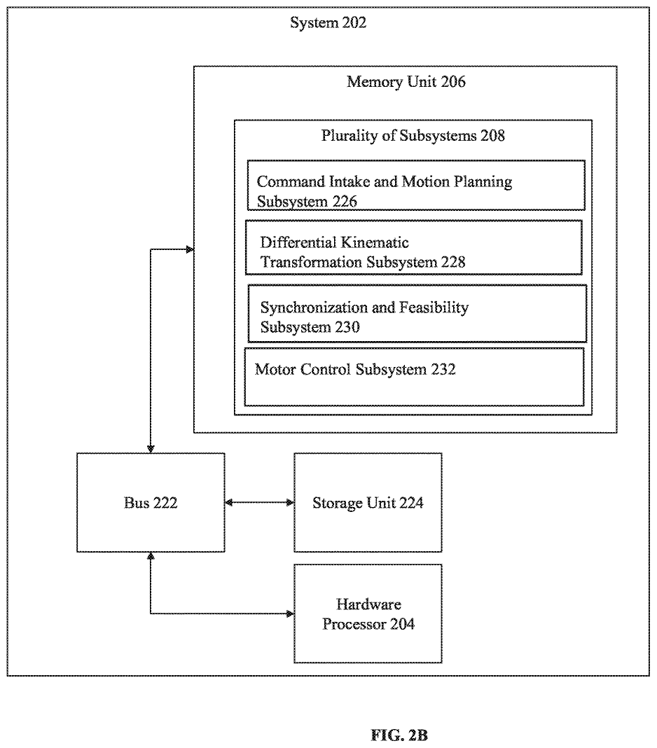

FIG. 2A depicts an example architecture 200 in which the methods of FIG. 1 of the present embodiments may operate. The architecture 200 can include a system 202, database 210, communications network 212, communications devices 214, and an additive manufacturing device 216. The system 202 can include hardware processors 204 and a memory unit 206.

The architecture 200 can include a system 202 that includes a hardware processor 204. The one or more hardware processors 204, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, such as generic or programmable logic devices or arrays, application-specific integrated circuits, single-chip computers, and the like.

The memory unit 206 can include a plurality of subsystems 208. The memory unit 206 may be the non-transitory volatile memory and the non-volatile memory. The memory unit 206 may be coupled to communicate with the one or more hardware processors 204, such as being a computer-readable storage medium. The one or more hardware processors 204 may execute machine-readable instructions and/or source code stored in the memory unit 206. A variety of machine-readable instructions may be stored in and accessed from the memory unit 206. The memory unit 206 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 206 can include the plurality of subsystems 208.

The plurality of subsystems 208 can be stored in the form of machine-readable instructions on any of the above-mentioned storage media and may be in communication with and executed by the one or more hardware processors 204. A computer system (standalone, client or server computer system) configured by an application may constitute a “module” (or “subsystem”) that is configured and operated to perform certain operations. In one embodiment, the “module” or “subsystem” may be implemented mechanically or electronically, so a module can include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The architecture 200 can include a database 210. The database 210 may include, but is not limited to, storing and managing data related to motion control, extrusion control, calibration, and operational state of the additive manufacturing device 216. The database 210 can serve as a central repository for cross-referencing motion commands, kinematic parameters, and performance metrics. The database 210 can include structured and unstructured data supporting operation of the system 202 and its subsystems 208. This can include toolpath metadata (print identifiers, layer indices, material types, and timestamps), motor configuration parameters, belt geometry definitions, pulley ratios, and differential kinematic matrices used to resolve translation and extrusion. In some embodiments, the database stores differential transformation parameters, including geometric constants (e.g., motor pulley circumference values, extrusion pulley ratios), transformation matrices defining mappings between task space and motor space, and calibration coefficients derived during system setup. The database 210 may further maintain historical motion logs, commanded displacement vectors (ΔX, ΔY, ΔE), computed motor actuation values (401 . . . Δθₙ), acceleration limits, jerk constraints, and stall-detection thresholds. Experimental performance data, including maximum acceleration before losing steps under various extrusion loads, may also be stored for comparative analysis and optimization. During operation, system 202 may write motion commands, execution results, sensor feedback, and detected error conditions received from the additive manufacturing device 216 to the database. The system may retrieve stored calibration constants, prior kinematic parameters, torque allocation weights, or historical performance profiles to refine motor command generation and acceleration planning. The database 210 may also store quality metrics, print validation results, and residual positioning error values associated with completed builds. In this implementation, the database functions as a persistent data repository that supports differential kinematic computation, parameter calibration, performance optimization, and reproducible motion control across printing sessions. The architecture 200 can include a communications network 212. The communications network 212 can include one or more communications networks 212 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-fi), cellular networks (including 2G (fourth generation), 2G (fifth generation), and 2G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The communication networks 212 can be configured to facilitate data exchange and communication between the system 202 and the database 210 for real-time data analysis.

The architecture 200 can include communications devices 214. The communications devices 214 can be one or more communication devices 214 and may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 214 can be configured to function as an intermediate unit between the system 202 and one or more users. The one or more communication devices 214 can be equipped with a user interface that allows the one or more users to interact with the system 202. The user interface may include graphical displays, touchscreens, voice recognition, and other input/output mechanisms that facilitate easy access to data and control functions.

The architecture 200 can include the additive manufacturing device 216. The additive manufacturing device 216 may be implemented as an FDM three-dimensional printing platform configured to deposit thermoplastic or similar build material in a layer-by-layer manner to fabricate physical objects. In some implementations, the additive manufacturing device 216 is a belt-driven motion system incorporating a differential actuation architecture in which translation of an extrusion module and rotation of an extruder shaft are produced from coordinated motion of a plurality of stationary motors. Some implementations can include Cartesian, CoreXY-type, or hybrid planar gantry configurations, although any additive manufacturing system capable of controlled multi-axis positioning and filament deposition can be used.

The additive manufacturing device 216 can include a motion subsystem comprising a support frame, linear guide members, and a movable extrusion module mounted for translation along one or more axes relative to the frame. A plurality of motors may be fixed to the support frame and mechanically coupled to corresponding continuous belts routed through guide pulleys. The belts engage a pulley mechanically coupled to an extruder shaft positioned on the extrusion module. The extruder shaft drives a filament engagement mechanism configured to advance or retract filament. The motion subsystem may further include a build surface mounted for controlled movement along an additional axis, enabling coordinated planar deposition.

During operation, the additive manufacturing device 216 can execute toolpath instructions by resolving commanded translational displacement and extrusion displacement into coordinated motor actuation values based on a differential kinematic relationship. Cooperative motor rotation may generate rotation of the extruder shaft to extrude filament, while differential motor rotation may generate translation of the extrusion module. The additive manufacturing device 216 may support high-speed motion, synchronized extrusion control, and programmable acceleration profiles. The additive manufacturing device 216 can communicate with system 202 through the communications network 212, enabling transfer of motion commands, status information, sensor feedback, and print data. In some implementations, the additive manufacturing device 216 functions as the physical fabrication component that generates the printed object based on control inputs produced by the processing subsystems. Those of ordinary skilled in the art will appreciate that the hardware depicted in FIG. 2A may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 202 as is unique to the present disclosure or necessary for an understanding of the present disclosure is depicted and described. The remainder of the construction and operation of the system 202 may conform to any of the various current implementations and practices that were known in the art.

FIG. 2B is a block diagram showing an example system 202 of the present embodiments along with its corresponding subsystems. The system 202 can include a memory unit 206, bus 222, storage unit 224, and hardware processor 204. The memory unit 206 can include a plurality of subsystems 208, which can include a command intake and motion planning subsystem 226, a differential kinematic transformation subsystem 228, a synchronization and feasibility subsystem 230, and a motor control subsystem 232.

The system 202 can include a memory unit 206. The memory unit 206 can be identical to the memory unit 206 described in FIG. 2A, and for the sake of brevity, is not described further here. The system 202 can include a bus 222. The system bus 222 can function as a central conduit for data transfer and communication between the one or more hardware processors 204, the memory unit 206, and the storage unit 224. The system bus 222 facilitates the efficient exchange of information and instructions, enabling a coordinated operation of the system 202. The system bus 222 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system 202 can include a storage unit 224. The storage unit 224 may be a cloud storage or the database 210, such as those shown in FIG. 2A. The storage unit 224 may store, but not limited to, recommended course of action sequences dynamically generated by the system 202. These action sequences can include data-obtaining, data processing, instruction interpreting, adaptive, and the like. The storage unit 224 may be any kind of database such as, but not limited to, relational databases, dedicated databases, dynamic databases, monetized databases, scalable databases, cloud databases, distributed databases, any other databases, graph databases, vector databases, and a combination thereof.

The system 202 can include a command intake and motion planning subsystem 226. This subsystem can ingest standard toolpath instructions (e.g., G-code) and represents each segment as a commanded motion state: translation targets/velocities (ΔX, ΔY) plus extrusion targets (ΔE), along with timing/jerk/acceleration constraints. The command intake and motion planning subsystem 226 can serve as the front-end computational layer that converts high-level fabrication instructions into structured motion objectives suitable for differential actuation. It can transform symbolic toolpath descriptions-typically expressed in standardized machine instruction languages such as G-code-into a sequence of mathematically defined motion states that can be consumed by downstream kinematic and control modules.

At the intake stage, the command intake and motion planning subsystem 226 parses incoming toolpath instructions that specify desired printer behavior in geometric and process-oriented terms. These instructions may include positional commands (e.g., move to a coordinate), extrusion commands (e.g., deposit a specified amount of material), and operational constraints such as feed rate or motion mode. Rather than treating these as isolated commands, the command intake and motion planning subsystem 226 organizes them into a continuous trajectory description. Each instruction can be interpreted within the current machine state, including the present spatial position, extrusion state, and active coordinate system. This contextual interpretation allows the command intake and motion planning subsystem 226to compute incremental motion requirements rather than absolute commands alone.

Following parsing, the command intake and motion planning subsystem 226 can convert each toolpath segment into a commanded motion state vector defined in task space. Conceptually, each segment is represented by translational displacement components and an extrusion displacement component. For planar motion systems, these may be expressed as ΔX and ΔY for spatial displacement, and ΔE for filament advancement or retraction. In addition to displacement, the command intake and motion planning subsystem 226 can assign dynamic attributes to each segment, including target velocity, allowable acceleration, and jerk limits that define how rapidly acceleration may change. These parameters collectively determine how the motion should be executed over time, not merely where it should end.

The command intake and motion planning subsystem 226 can therefore perform both geometric and temporal planning. Geometrically, it determines the direction and magnitude of motion required to traverse each segment of the toolpath. Temporally, it computes a feasible motion profile that respects mechanical and process constraints. For example, acceleration limits prevent excessive inertial loading, while jerk constraints reduce vibration and preserve deposition quality. Feed rate specifications from the toolpath are reconciled with these constraints to determine segment duration and velocity shaping. The result can be a time-parameterized motion segment that describes not only displacement but also how that displacement evolves continuously over the execution interval. In some implementations, translation and extrusion are represented as coordinated components of a single commanded state. Material deposition is therefore not necessarily treated as an independent process but as a synchronized dimension of motion. Each motion segment encodes a coupled trajectory in which spatial displacement and extrusion displacement share a common temporal framework. This unified representation enables subsequent differential kinematic transformations to operate on a coherent task-space description. Thereby, the command intake and motion planning subsystem 226 converts symbolic manufacturing instructions into structured, time-parameterized motion states. By parsing toolpath commands, computing incremental spatial and extrusion displacements, and assigning dynamic execution constraints, it produces a sequence of coordinated motion vectors that fully describe the intended physical behavior of the additive manufacturing system.

The system 202 can include a differential kinematic transformation subsystem 228. The differential kinematic transformation subsystem 228 can implement the forward/inverse mappings between task space and motor space. Conceptually, it can receive an input vector=[ΔX, ΔY, ΔE] T or [ΔX, ΔE] T and produce an output motor vector θ=[Δθ₁ . . . . Δθₙ]^{T} via a linear transform θ=K·u and/or u=D·θ, where K/D encode pulley/belt geometry and sign conventions. The differential kinematic transformation subsystem 228 can serve as the mathematical core that converts commanded motion objectives in task space into coordinated motor actuation in motor space, and, when required, performs the inverse mapping from motor motion back to physical system behavior. Its role is to implement the functional relationship between desired physical outputs, translation and extrusion, and the mechanical inputs provided by multiple motors that are differentially coupled through belts and pulleys.

In some implementations, the differential kinematic transformation subsystem 228 receives a task-space motion vector that represents the intended physical displacement of the extrusion module over a motion segment. Conceptually, this vector can be expressed as u=[ΔX, ΔY, ΔE]^{T}, where ΔX and ΔY represent commanded spatial displacements along orthogonal axes and ΔE represents commanded extrusion displacement. This vector describes what the system is intended to do physically, independent of how individual motors must move to achieve that behavior.

Because the mechanical architecture couples translation and extrusion through a differential belt system, no singular motor corresponds directly to a single output axis. Instead, each motor contributes simultaneously to multiple physical outputs. The subsystem therefore applies a transformation that resolves the desired physical motion into coordinated motor displacements. This can be accomplished by multiplying the task-space vector by a transformation matrix that encodes the system's mechanical geometry. The resulting motor-space vector is θ=[Δθ₁, Δθ₂, . . . , Δθₙ]^{T}=K·u, where each Δθᵢ represents the required angular displacement of a corresponding motor. The matrix K contains constants determined by the belt routing topology, pulley diameters, transmission ratios, and directional sign conventions. These parameters can define how individual motor rotations combine to produce translation and extrusion, and therefore uniquely characterize the differential mechanism.

The differential kinematic transformation subsystem 228 also supports the inverse relationship, expressed as u=D·θ, where matrix D maps motor displacements to resulting physical motion. This forward mapping can be utilized for system monitoring, simulation, calibration, and validation, allowing the controller to compute actual translation and extrusion resulting from measured motor motion. The matrices K and D can be inverses or pseudo-inverses of one another, depending on system redundancy. In some implementations the differential kinematic transformation subsystem 228 performs this transformation on a segment-by-segment basis. Each commanded motion vector is converted into a synchronized set of motor displacements that, when executed together, produce the intended combined translation and extrusion. Because the transformation is linear, superposition applies: motor contributions to each physical output sum algebraically according to the transformation coefficients. This linearity provides predictable coordination and simplifies real-time control. The transformation matrices are not abstract constants but calibrated representations of the machine's physical configuration. Changes in pulley size, belt routing, or mechanical layout alter the mapping and can be reflected in updated coefficients. In this way, the differential kinematic transformation subsystem 228 can function as a parametric model of the machine's differential kinematics. Thereby, the differential kinematic transformation subsystem 228 translates between physical intent and mechanical execution. By applying linear mappings between task space and motor space, it resolves coupled motion commands into coordinated motor actuation and enables precise control of a multi-output differential drive system.

The system 202 can include a synchronization and feasibility subsystem 230. The synchronization and feasibility subsystem 230 can provide that the computed motor trajectories are physically consistent by time-aligning the motor profiles so translation and extrusion complete together, applies belt/motor limits (max speed/accel/torque), and optionally allocates load across motors to avoid saturating any one motor. The synchronization and feasibility subsystem 230 can operate as the dynamic consistency layer of the control architecture, providing that the motor commands produced by the differential kinematic transformation can be executed physically, safely, and in coordinated time. While the kinematic subsystem determines what motor displacements are required to achieve a commanded translation and extrusion, the synchronization and feasibility layer determines how those displacements can be executed within the mechanical and dynamic limits of the system.

A function of the synchronization and feasibility subsystem 230 can be temporal alignment. Because translation and extrusion are derived from shared motor motion, each motor must follow a trajectory that collectively produces the desired physical outcome over the same time interval. If one motor were to complete its commanded displacement earlier than another, the intended balance between translational and rotational components would be disrupted, producing unintended motion or extrusion. To prevent this, the synchronization and feasibility subsystem 230 constructs time-parameterized motion profiles for each motor and synchronizes their start times, durations, and intermediate velocity phases. This provides that the combined motor actions produce the commanded translation and extrusion simultaneously and continuously over the motion segment. In addition to temporal alignment, the synchronization and feasibility subsystem 230 enforces feasibility constraints based on the physical capabilities of the machine. Each motor and transmission path can have limits on rotational speed, angular acceleration, and available torque. Likewise, belts and pulleys impose mechanical constraints related to tension, slip, and inertial loading. The synchronization and feasibility subsystem 230 evaluates computed motor trajectories against these limits and modifies the trajectories when necessary to maintain safe operation. For example, if a commanded motion would require a motor to exceed its maximum speed, the subsystem may scale the overall motion duration, reduce acceleration rates, or reshape the velocity profile while preserving the proportional relationship among motor displacements. This preserves the intended geometric motion while providing that no component operates outside its design envelope. The synchronization and feasibility subsystem 230 can also account for jerk and dynamic smoothness, controlling how rapidly acceleration changes over time. Limiting jerk reduces vibration, improves deposition quality, and prevents shock loading of belts and structural components. Motion profiles are therefore shaped to transition smoothly between velocity phases, often using ramped or polynomial interpolation schemes that respect both acceleration and jerk constraints.

An additional capability of the synchronization and feasibility subsystem 230 can be load distribution across motors. Because multiple motors contribute to shared outputs, the system 202 may possess degrees of actuation redundancy. When this occurs, the synchronization and feasibility subsystem 230 can allocate effort among motors to avoid overloading any single actuator. For instance, if one motor approaches its torque limit, the subsystem may redistribute motion components across other motors, provided the resulting combined motion still satisfies the differential kinematic relationships. This dynamic load balancing enhances reliability and enables more efficient use of available actuation capacity. Thereby, the synchronization and feasibility subsystem 230 acts as a gatekeeper that verifies physical realizability before motion is executed. It provides that computed trajectories are internally consistent, dynamically smooth, and compatible with hardware constraints. By coordinating timing, enforcing limits, and optionally balancing actuator loads, the synchronization and feasibility subsystem 230 transforms mathematically valid motor commands into physically executable motion plans that preserve the intended relationship between translation and extrusion throughout the printing process.

The system 202 can include a motor control subsystem 232. The motor control subsystem 232 can generate time-parameterized motor trajectories (step/directional pulses or equivalent) from the motor-space commands, including acceleration profiles, step interpolation, and segment blending to avoid discontinuities. The motor control subsystem 232 can function as the execution layer that converts synchronized motor-space commands into precisely timed electrical drive signals that physically actuate the motors. While upstream subsystems determine what motor displacements are required and ensure those displacements are dynamically feasible, the motor control subsystem 232 determines how those displacements are realized over time with sufficient resolution, smoothness, and continuity to produce accurate mechanical motion. At its input, the motor control subsystem 232 receives motor displacement commands expressed in motor space, typically as angular increments and associated timing constraints derived from prior synchronization and feasibility processing. These commands define the total motion required for each motor over a segment, but do not yet specify the detailed temporal evolution of that motion. The motor control subsystem 232 therefore generates time-parameterized trajectories that describe motor position, velocity, and acceleration as continuous functions of time. To produce these trajectories, the motor control subsystem 232 can construct acceleration profiles that shape how motor speed changes during a motion segment. Rather than commanding instantaneous changes in velocity, which would be physically unrealistic and mechanically disruptive, the motor control subsystem 232 can generate controlled ramping behavior. This may include trapezoidal velocity profiles, S-curve acceleration shaping, or higher-order interpolation that limits jerk. These profiles can provide smooth transitions between motion states, reduce vibration, and maintain adherence to mechanical constraints established earlier in the control pipeline.

Once a continuous trajectory has been defined, the motor control subsystem 232 converts it into discrete drive signals compatible with the motor hardware. For stepper-driven systems, this can involve generating step and direction pulses whose timing corresponds to the instantaneous velocity specified by the trajectory. The interval between successive pulses can be modulated so that cumulative pulse count matches the required displacement while instantaneous pulse frequency reflects the desired velocity profile. For other motor types, equivalent control signals, such as phase currents or position setpoints, may be generated, but the underlying objective remains the same: to translate continuous trajectory descriptions into hardware-level actuation signals. Because motion is executed as a sequence of contiguous segments, the motor control subsystem 232 also performs step interpolation and segment blending. Step interpolation provides that discrete pulses approximate the intended continuous trajectory with high temporal resolution, minimizing quantization error and preserving smooth motion. Segment blending addresses the transitions between successive motion segments. Rather than stopping at the end of one segment and abruptly starting the next, the motor control subsystem 232 can merge adjacent segments by maintaining velocity continuity and smoothly adjusting acceleration. This blending can prevent discontinuities that would otherwise introduce mechanical shock, lost steps, or deposition artifacts.

The motor control subsystem 232 therefore can operate at high temporal resolution, managing microsecond-scale timing to maintain precise synchronization among multiple motors. It can continuously track commanded positions, updates pulse timing, and provides that each motor's execution remains aligned with the shared motion plan. Thereby, the motor control subsystem 232 translates motor displacement commands into finely timed actuation signals that produce smooth, continuous mechanical motion. By generating acceleration-shaped trajectories, interpolating discrete control pulses, and blending successive motion segments, it provides that coordinated translation and extrusion are executed accurately and without dynamic discontinuities.

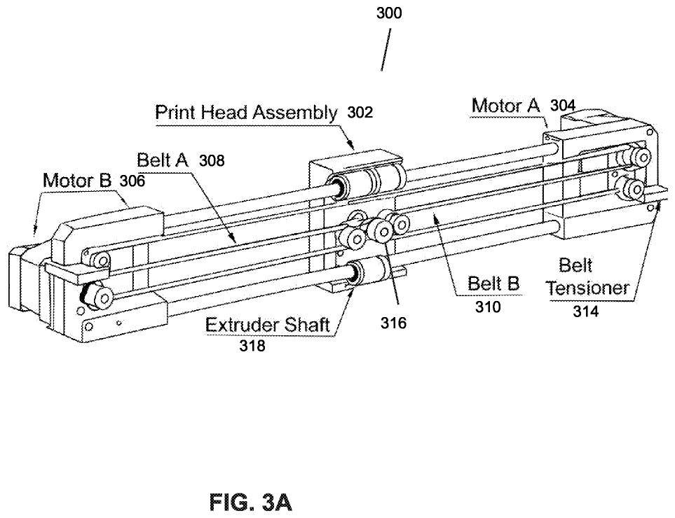

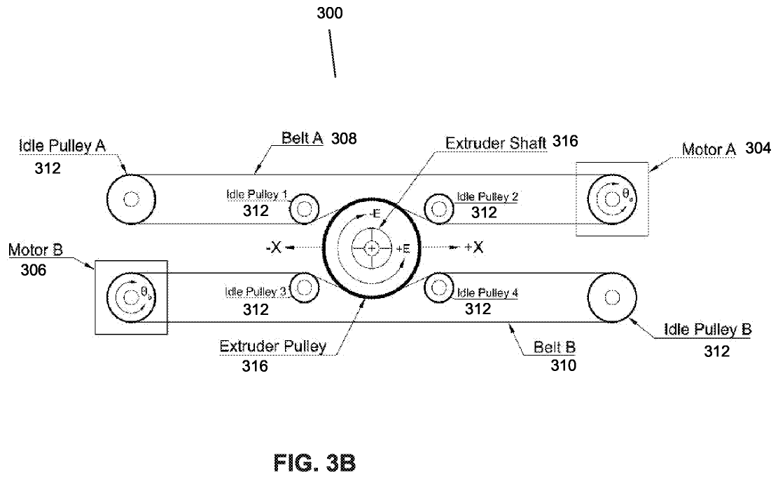

FIG. 3A illustrates a cutaway view of a differentially driven extrusion and translation system 300 of the present implementations, showing the spatial relationship between the stationary drive components and the movable print head assembly 302. The system includes Motor A 304 and Motor B 306 mounted at opposite ends of the X-axis support structure. Both motors are fixed relative to the frame and do not translate with the print head assembly. Each motor drives a respective closed-loop toothed belt, Belt A 308 and Belt B 310, which extend longitudinally along the axis of motion. Belts are shown here as toothed, but can include teeth on both sides, one side, or neither side.

Belt A 308 is driven by Motor A 304 and routed through a series of guide pulleys 312 and tensioning elements 314 before engaging the extrusion pulley 316 carried by the print head assembly 302. Similarly, Belt B 310 is driven by Motor B 306 and routed along a parallel path, engaging the extrusion pulley316 from the opposite side. The belts are arranged so that they contact the extrusion pulley 316 at opposing circumferential regions, thereby enabling differential force and torque transmission. The belt tensioner 314 can provide proper belt preload, minimizing backlash and maintaining consistent belt engagement during rapid acceleration and deceleration. The print head assembly 302 is mounted for linear motion along guide rods or rails extending along the X-axis. The extrusion shaft 318 is supported within the print head assembly and is mechanically coupled to the extrusion pulley 316 that interfaces with Belt A 308 and Belt B 310. The extrusion shaft 318 is free both to rotate about its longitudinal axis and to translate laterally with the print head assembly 302. When Motor A 304 and Motor B 306 rotate in the same direction, their respective belts impart torque to the extrusion pulley in a cooperative manner. This produces rotational motion of the extrusion shaft without substantial lateral displacement of the print head assembly, thereby advancing or retracting filament. Conversely, when the motors rotate in opposite directions, the torques applied to the extrusion pulley substantially cancel while the lateral belt forces combine to produce linear translation of the print head assembly along the X-axis. When the motors rotate at differing magnitudes or rates, the system generates both rotational and translational motion simultaneously.

FIG. 3B is a conceptual representation of the system 300 shown in FIG. 3A, illustrating the functional belt routing and differential interaction between the motors and the extrusion pulley without the surrounding structural components of the print head assembly 302. Motor A 304 and Motor B 306 are positioned at opposite ends of the axis of motion and are fixed relative to the printer frame. Each motor drives a respective belt, Belt A 308 and Belt B 310, which are shown schematically as linear belt segments routed through idle pulleys 312. Idle Pulley A and Idle Pulley B redirect the belts at the ends of the axis, maintaining proper alignment and tension while defining the overall belt path geometry. Additional idle pulleys 312 (Idle Pulley 1 through Idle Pulley 4) are positioned adjacent to the central extrusion pulley to control belt wrap angle and ensure stable engagement with the extrusion pulley. At the center of the diagram is the extrusion pulley 316, which is mechanically coupled to the extrusion shaft 318 and mounted so that it can both rotate about its central axis and translate laterally along the X-axis. Belt A 308 engages one side of the extruder pulley while Belt B 310 engages the opposite side. This opposing engagement enables the pulley to experience either net torque, net lateral force, or a combination of both, depending on the relative motion of the two belts. When Motor A 304 and Motor B 306 rotate in the same direction, Belt A 308 and Belt B 310 move cooperatively around the extruder pulley, generating a net rotational torque on the extrusion pulley. This causes the extrusion shaft to rotate, advancing or retracting filament, while the opposing lateral forces substantially cancel, minimizing translation along the X-axis. Conversely, when the motors rotate in opposite directions, the rotational torques applied by the belts substantially cancel, while the lateral belt forces add in the same direction, producing translation of the extruder pulley and attached print head along the X-axis, as indicated by the +X arrows. If the motors rotate at differing speeds or magnitudes, the system simultaneously produces rotation and translation.

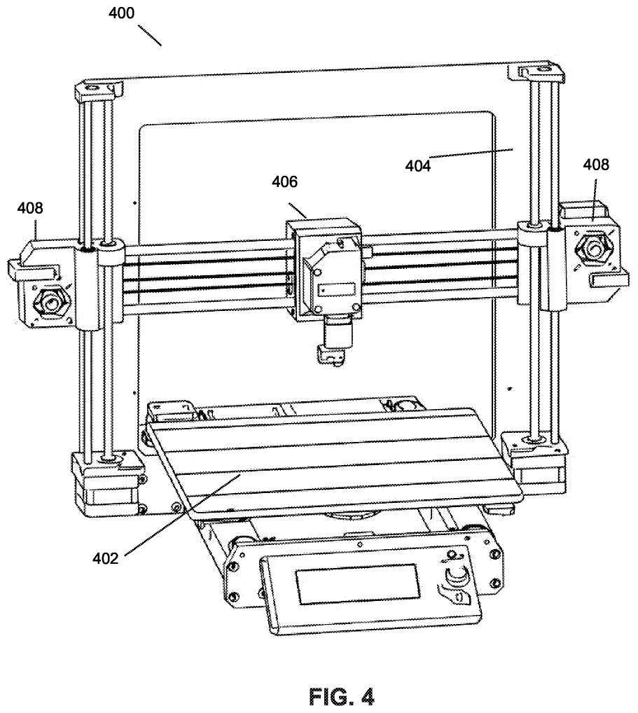

FIG. 4 show additive manufacturing apparatus 400 incorporating the differential extrusion and X-axis translation system described in FIGS. 3A and 3B, in an implementation where motion along the Y-axis is provided by a movable build plate 402 positioned beneath the print head assembly. In this implementation, the printer frame 404 supports vertical guide members and a horizontal gantry structure along which the print head assembly translates in the X direction. The print head assembly 406 is mounted on the horizontal cross-member and contains the extrusion shaft and associated pulley engaged by the dual-belt differential drive system, as shown in FIG. 3A and FIG. 3B. Motors 408 positioned at opposite ends of the X-axis remain stationary relative to the frame and drive their respective belts, which cooperate to generate both extrusion and X-axis translation as previously described. Thus, X motion and filament advancement are resolved through coordinated rotation of the stationary motors, eliminating the need for a dedicated extrusion motor mounted on the moving print head. Beneath the print head assembly is a build plate 402 mounted on a Y-axis carriage. The plate 402 is supported on linear rails and driven by a separate Y-axis actuation system, such as a lead screw or belt-driven carriage, which is independent of the differential extrusion system. Movement of the build plate in the Y direction repositions the workpiece relative to the print head while the print head itself translates only along the X-axis. In operation, coordinated control of the X-axis differential system and the Y-axis plate drive allows planar toolpath motion across the build surface. During printing, X-axis motion is produced by differential rotation of the stationary motors, where opposite motor rotation produces lateral translation of the print head assembly, and cooperative motor rotation produces rotation of the extrusion shaft to advance filament. Simultaneously, the Y-axis drive moves the build plate forward or backward to achieve two-dimensional positioning. Because the extrusion drive is integrated into the X-axis differential system, the print head assembly carries only the extrusion shaft and filament engagement mechanism, reducing moving mass relative to traditional direct-drive extruder configurations that include a dedicated extrusion motor on the gantry.

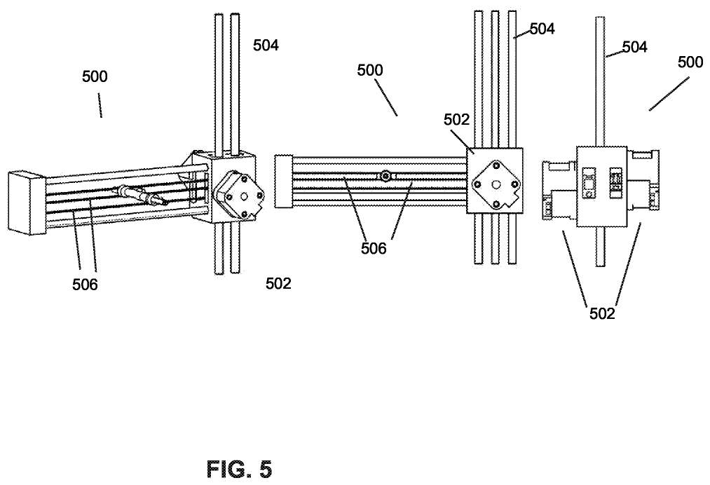

FIG. 5 illustrates multiple views of an alternative embodiment of the differential extrusion and translation system 500 in which both stationary motors 502 are positioned on a single side of the support structure 504 rather than at opposite ends of the X-axis. Shown are top, front, and perspective views to clarify belt 506 routing, motor placement, and the structural integration of the extrusion assembly within this single-sided drive configuration. In this embodiment, Motor A and Motor B are mounted adjacent to one another on the same side of the support frame 504. Both motors 502 remain stationary relative to the frame and drive respective closed-loop belts 506 that extend longitudinally along the axis of motion. From the motor side, the belts are routed along parallel paths across the gantry through idler pulleys that redirect belt travel toward the movable print head assembly. The belt paths are arranged so that they engage opposite sides of the extrusion pulley carried by the print head assembly, despite originating from the same side of the frame. The print head assembly (not shown) remains supported for translation along the X-axis via linear rods or rails. The extrusion shaft is mounted within the assembly and coupled to the extrusion pulley that interfaces with both belts. As in prior embodiments, the extrusion pulley is free to both rotate about its axis and translate laterally with the print head. The routing geometry ensures that the belts apply both torque and lateral force components depending on relative motor rotation. When Motor A and Motor B rotate cooperatively in the same direction, the belts impart net rotational torque to the extrusion pulley, causing rotation of the extrusion shaft and advancement or retraction of filament, while lateral forces substantially cancel. When the motors rotate in opposite directions, torque components substantially cancel while lateral belt forces combine to produce translation of the print head along the X-axis. If the motors rotate at differing magnitudes, the resulting motion is a superposition of translation and extrusion. By locating both motors 502 on one side of the support, this implementation can centralize mass and simplify wiring and structural layout while maintaining the same differential operating principle. The mechanical resolution of translation and extrusion remains governed by the symmetric and antisymmetric combinations of motor rotation, but the belt routing topology is modified to accommodate the single-sided motor placement.

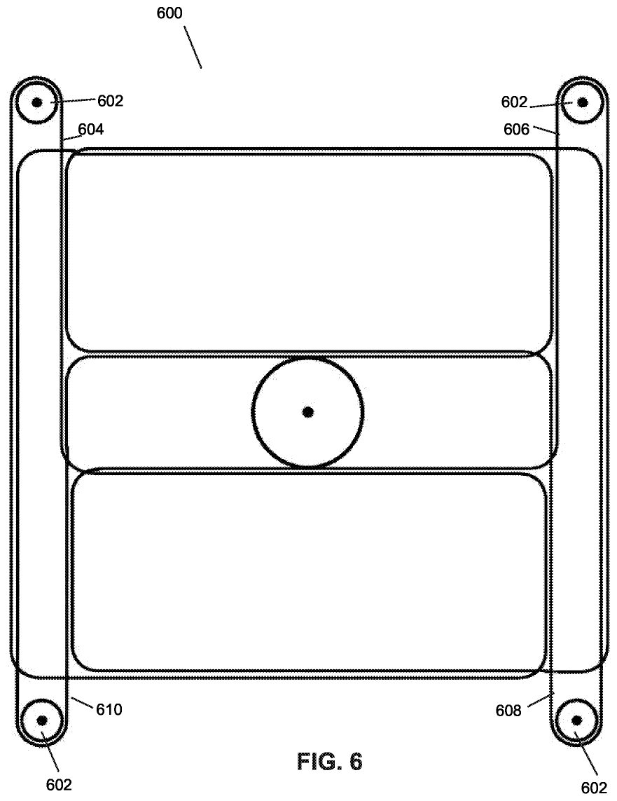

FIG. 6 is a conceptual schematic illustrating an implementation in which both X-axis and Y-axis translation are controlled by motors 602 positioned at the corners of the support structure, with the various closed loops representing distinct belt paths 604-610 used to resolve planar motion and extrusion through differential actuation. Unlike the prior embodiments where Y motion was provided by a moving build plate or where motors were positioned along a single axis, in this system 600, a fully gantry-driven architecture is shown in which coordinated rotation of multiple corner-mounted motors produces two-dimensional translation of the print head assembly. In this conceptual drawing, motors 602 are located at the four corners of the frame, and each motor drives a respective belt loop 604-610 routed along the perimeter and across the gantry. The illustrated loops represent independent belt paths 604-610 that wrap around corner pulleys and traverse the frame in orthogonal directions. These belt paths 604-610 are arranged so that their motion components combine vectorially at the movable carriage. The central circular element represents the extrusion pulley or print head interface point, which is supported for planar motion relative to the frame. The belt routing is configured such that different linear combinations of motor rotations produce displacement along the X-axis, the Y-axis, or a combination of both. For example, synchronized rotation of a pair of diagonally opposed motors may produce translation along one axis, while synchronized rotation of the orthogonal pair produces translation along the perpendicular axis. When multiple motors rotate simultaneously with differing magnitudes or directions, the resulting displacement is the superposition of the individual axis components, enabling arbitrary planar motion across the build area. Because each belt loop contributes force components in both orthogonal directions, the system 600 operates as a multi-input differential planar mechanism. The translational displacement vector of the carriage can be expressed as a linear combination of the individual motor angular displacements scaled by pulley geometry and belt orientation. The closed-loop routing maintains belt tension and ensures that motion imparted by the motors is transmitted efficiently to the moving assembly.

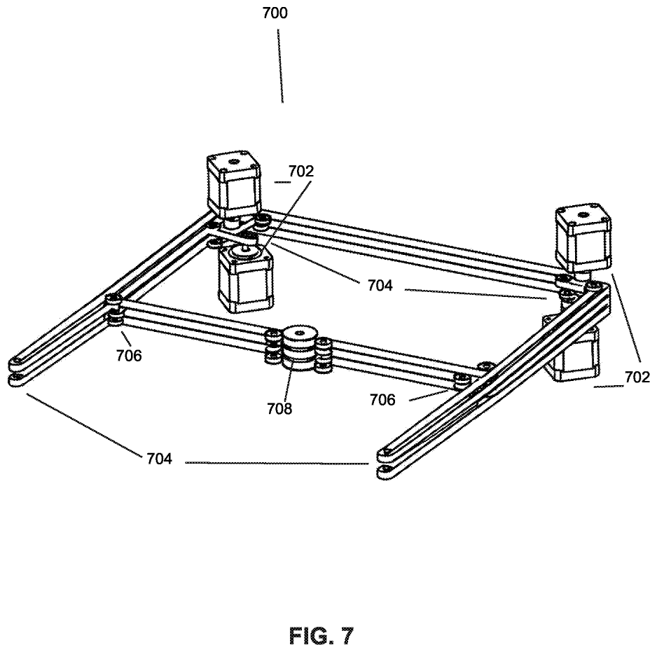

FIG. 7 illustrates an implementation of the differential motion architecture 700 implemented with four motors 702 positioned at the corners of the support structure, two on each side, providing coordinated control of planar translation and extrusion. In this configuration, each motor is stationary relative to the frame and drives a respective belt path routed through a series of idle pulleys 704. The smaller circular elements positioned near the corners represent stationary idle pulleys 704, which are fixed relative to the frame and serve to redirect and tension the belts along defined geometric paths. These stationary idle pulleys 704 establish the primary belt routing topology and maintain consistent wrap angles around the driven pulleys 708.

At the center of the system 700 are two controllable wheels, which function as driven pulleys 708 mechanically coupled to the movable carriage or extrusion assembly. These central wheels are engaged by the belts such that coordinated motor rotation produces controllable motion components. Depending on the belt routing and control inputs, the central wheels may resolve motor motion into translation along one or more axes and/or rotation of an extrusion shaft. Also located near the center are additional idle pulleys that may be configured as floating idle pulleys 706. Unlike the stationary idle pulleys in the corners, these floating idle pulleys 706 are mounted so that they can translate with the carriage, particularly to accommodate Y-axis motion. Their floating nature allows belt tension to be maintained while permitting relative movement between the carriage and the frame in the orthogonal direction. This design enables decoupling of belt path constraints from the orthogonal axis of motion, thereby supporting planar X-Y translation. In operation, the four corner-mounted motors702 generate motion components that combine vectorially at the central controllable wheels. For example, coordinated rotation of motors on one side may produce X-direction translation, while coordinated rotation of motors on the opposing side contributes complementary or opposing force components. Differential combinations of the four motor inputs allow translation along both X and Y axes, and if one of the central wheels is coupled to an extrusion shaft, symmetric combinations of motor motion may also generate extrusion torque.

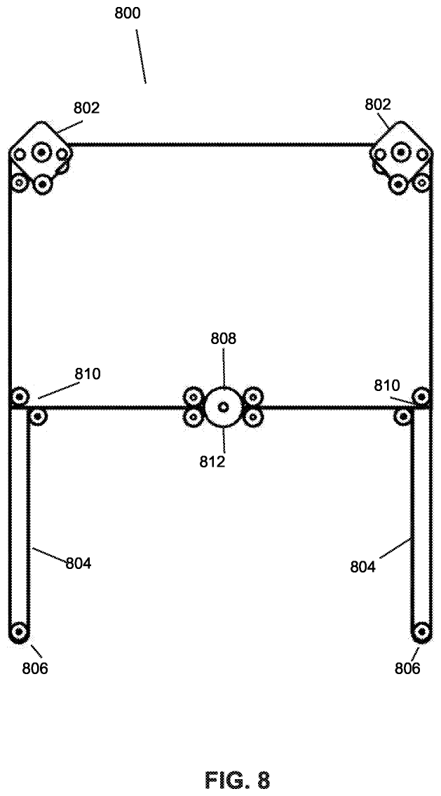

FIG. 8 is an overhead conceptual representation of the multi-motor differential architecture 800 illustrated in FIG. 7, presented in a simplified top-down view to emphasize belt routing geometry and force resolution within the planar X-Y system. As shown, motors are positioned at opposing upper corners of the frame, each motor 802 driving a belt 804 that extends laterally across the top span and downward along vertical belt paths. The belts are routed around stationary idle pulleys 806 positioned near the corners and lower frame intersections. These stationary idle pulleys 806 are fixed relative to the frame and serve to define the rectangular belt routing envelope, maintain belt tension, and redirect belt direction without contributing active motion. At the midpoint of the horizontal cross-span is a central controllable pulley assembly 808, which may be mechanically coupled to a carriage or extrusion mechanism. Flanking the central driven pulley 812 are smaller idle pulleys that may be configured as floating idle pulleys 810. Unlike the stationary idle pulleys, these floating idle pulleys are supported on the movable carriage so that they translate with it, particularly along the Y-axis. Their floating configuration preserves belt alignment and tension as the carriage moves orthogonally relative to the frame.

In operation, rotation of the corner-mounted motors produces coordinated belt motion around the closed-loop paths. Because the belts 804 engage the central controllable pulley 812 from opposing directions, differential combinations of motor rotation produce net force components in orthogonal planar directions. For example, symmetric motor rotation may generate one axis of motion, while antisymmetric combinations generate motion along the perpendicular axis. If the central pulley 812 is coupled to an extrusion shaft, additional symmetric components of belt motion may generate rotational torque for filament advancement.

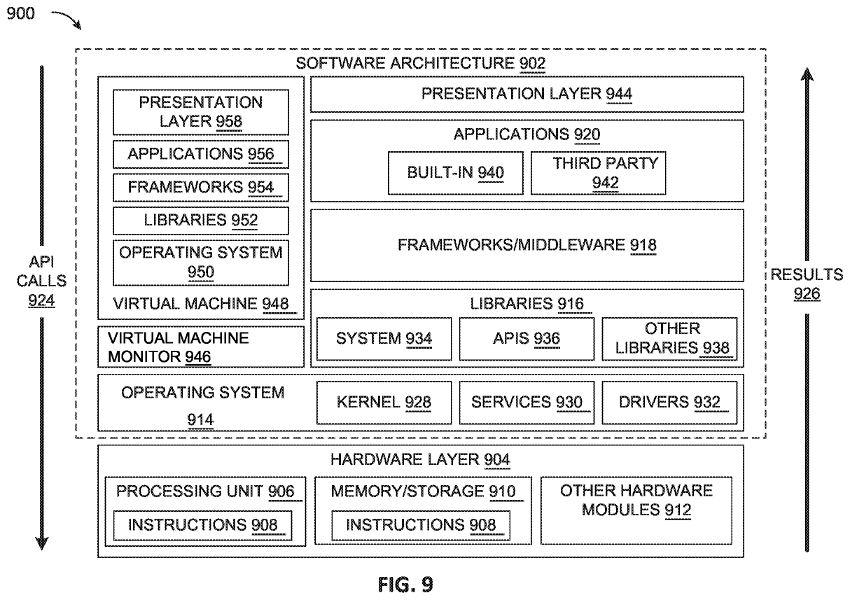

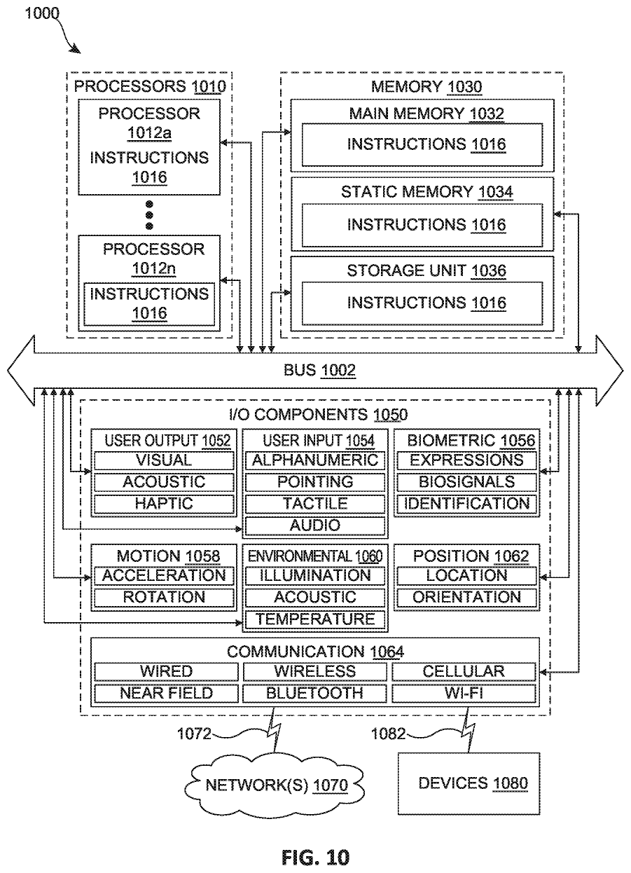

FIG. 9 is a block diagram 900 illustrating an example software architecture 902, various portions of which may be used in conjunction with various hardware architectures herein described, which may implement any of the above-described features. FIG. 9 is a non-limiting example of a software architecture, and it will be appreciated that many other architectures may be implemented to facilitate the functionality described herein. The software architecture 902 may execute on hardware such as a machine 1000 of FIG. 10 that includes, among other things, processors 1010, memory/storage, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks/middleware 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks/middleware 918 provide a higher-level common infrastructure that may be used by the applications 920 and/or other software modules. For example, the frameworks/middleware 918 may provide various graphic user interface (GUI) functions, high-level resource management, or high-level location services. The frameworks/middleware 918 may provide a broad spectrum of other APIs for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks/middleware 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an OS 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory/storage 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multicore processor including cores that may execute instructions contemporaneously. Although FIG. 10 shows multiple processors, the machine 1000 may include a single processor with a single core, a single processor with multiple cores (for example, a multicore processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1064, such as, but not limited to, geo-location via Internet Protocol (IP) address, location via Wi-Fi, cellular, NFC, Bluetooth, or other wireless station identification and/or signal triangulation.

In certain implementations, an additive manufacturing apparatus includes a support frame that provides structural rigidity and defines a reference coordinate system for motion. An extrusion module is mounted relative to the support frame and configured to deposit material, such as thermoplastic filament, onto a build surface. The extrusion module is supported for translation along at least one axis, such as an X-axis, relative to the support frame. The extrusion module includes an extruder shaft that is operatively associated with a filament engagement mechanism and is configured to rotate in order to advance or retract filament during printing operations. A plurality of motors can be mounted to and fixed relative to the support frame such that the motors do not translate with the extrusion module. Each motor is independently controllable and is mechanically coupled to a respective continuous belt. Each belt is routed along the support frame through one or more guide pulleys and extends to the extrusion module, where it engages a pulley that is mechanically coupled to the extruder shaft. The belts are arranged along different belt paths such that they contact the pulley at different circumferential regions or from opposing directions. The belt routing geometry is configured so that forces applied to the pulley by the belts may be resolved into rotational and translational components. In particular, rotation of the extruder shaft is produced by a first combination of belt motion corresponding to a sum of motion contributions from the motors. When the motors rotate in a cooperative manner, the resulting belt motion generates a net torque on the pulley coupled to the extruder shaft, thereby causing filament extrusion or retraction without necessarily producing substantial translational displacement of the extrusion module. Conversely, translation of the extrusion module along the axis is produced by a second combination of belt motion corresponding to a difference of motion contributions from the motors. When the motors rotate in opposing directions, the torque contributions on the pulley may substantially cancel while lateral force components combine, thereby causing the extrusion module to translate along the axis without substantial rotation of the extruder shaft. In this manner, differential motion of the belts generated by the plurality of stationary motors simultaneously controls both translation of the extrusion module and extrusion of filament. The architecture integrates motion and extrusion control into a shared belt-driven system rather than relying on a dedicated extrusion motor mounted on the moving extrusion module.

In some embodiments, the motors are stationary relative to the support frame and no extrusion drive motor is mounted on the extrusion module itself. This arrangement reduces the moving mass of the extrusion module, which can improve achievable acceleration, reduce inertial loads, and enhance dynamic response during high-speed printing. The pulley engaged by the belts is configured to both rotate about its axis and translate with the extrusion module. That is, the pulley is mounted on the extrusion module such that it moves laterally with the module while also being free to rotate relative to the module to drive the extruder shaft.

Each belt may form a closed loop extending between its respective motor and one or more guide pulleys supported by the frame. The guide pulleys define the belt path geometry and maintain appropriate belt tension. The belts may engage opposite sides of the pulley coupled to the extruder shaft, thereby enabling differential resolution of forces. For example, one belt may wrap around one side of the pulley while the other belt wraps around the opposite side, such that belt tension differences produce lateral force and belt tension sums produce torque.

Synchronous rotation of the motors in a first direction may cause rotation of the extruder shaft without translation of the extrusion module. In such operation, both motors rotate in the same direction and by similar magnitudes, producing a net torque on the pulley while lateral forces substantially cancel. Conversely, counter-rotation of the motors may cause translation of the extrusion module without rotation of the extruder shaft. In this case, the motors rotate in opposite directions such that torque contributions cancel while lateral force components add to produce linear displacement. When the motors rotate at differing rates or magnitudes, the resulting belt motion includes both sum and difference components, thereby causing simultaneous translation of the extrusion module and rotation of the extruder shaft.

The apparatus may further include a controller configured to generate motor commands corresponding to desired extrusion displacement and translational displacement based on a differential kinematic relationship. The controller may compute motor rotation values that satisfy linear relationships between motor angular displacement and output translation and extrusion and may drive the motors in coordinated time to achieve the commanded motion. In certain embodiments, the extrusion module comprises a direct-drive filament engagement mechanism positioned on the extrusion module and driven directly by rotation of the extruder shaft, thereby providing responsive filament control while retaining the benefits of reduced moving mass.

### Example 1

In one example experiment, performance data between an unmodified Prusa i3 MK3 and the disclosed implementations under controlled experimental conditions was obtained. The comparison was conducted using identical stepper motors, motor drivers, and firmware settings in order to isolate the mechanical architecture as the primary variable. By maintaining consistent electrical and control parameters, the results reflect differences attributable to motion system design rather than component upgrades or tuning variations.

In a first test condition without extrusion, printhead speed was set to 600 mm/s, and maximum acceleration was increased until step loss occurred. Under these conditions, the stock Prusa i3 MK3 exhibited a maximum acceleration of approximately 32,000 mm/s² before losing steps. In contrast, the disclosed implementations did not stall even at accelerations exceeding 70,000 mm/s². This indicates that the differential belt-driven architecture is capable of sustaining significantly higher inertial loads without step loss, suggesting improved force distribution and reduced effective moving mass.

A second set of tests evaluated performance while actively extruding material at various layer heights and printhead speeds. At a 0.3 mm layer height and 125 mm/s print speed, both systems achieved accelerations greater than 70,000 mm/s² without stalling. However, as layer height decreased and print speed increased, performance differences became more pronounced. At 0.2 mm layer height and 187.5 mm/s, the Prusa i3 MK3 stalled at approximately 45,000 mm/s², whereas the disclosed implementations again demonstrated no stall at accelerations exceeding 70,000 mm/s². At 0.1 mm layer height and 375 mm/s, the Prusa maintained a 45,000 mm/s² limit, while the disclosed implementations continued to operate beyond 70,000 mm/s² without losing steps.

At the most demanding condition, 0.05 mm layer height and 750 mm/s print speed, the Prusa i3 MK3 exhibited step loss at approximately 25,000 mm/s², while the disclosed implementations sustained accelerations of approximately 45,000 mm/s² before stalling. Even under high-speed, low-layer-height extrusion conditions, the disclosed implementations maintained a substantially higher acceleration threshold.

Collectively, these results demonstrate that the disclosed implementations support materially higher acceleration limits than the conventional Prusa i3 MK3 design, both during non-extrusion motion and during active material deposition. The data suggest improved mechanical efficiency, better torque utilization, and enhanced stability under dynamic loading, enabling higher performance operation without loss of positional accuracy.

### Example 2

A second experiment evaluated whether increased extrusion load meaningfully reduces maximum achievable acceleration in the disclosed implementations, given that extrusion and translation are mechanically coupled. Because the system resolves both motion and filament advancement through coordinated motor inputs, a key question is whether higher extrusion forces consume available motor torque and thereby limit translational acceleration. To test this, progressively larger high-flow nozzles were used to increase volumetric extrusion load while maintaining identical motion hardware and control settings.

Three nozzle configurations were evaluated: a standard 0.4 mm nozzle operating at approximately 15 mm³/s, a 0.8 mm high-flow (HF) nozzle at approximately 28 mm³/s, and a 1.0 mm HF nozzle at approximately 36 mm³/s. Across multiple layer heights and print speeds, acceleration was increased until step loss occurred. At 0.3 mm layer height, all three nozzle configurations exhibited no stall at printhead speeds of approximately 116-125 mm/s. At 0.2 mm layer height, all configurations again showed no stall at approximately 175-188 mm/s. At 0.1 mm layer height, no stall occurred up to approximately 350-375 mm/s across all nozzle sizes.

Even at the most demanding condition—0.05 mm layer height and printhead speeds near 700-750 mm/s—the maximum acceleration before losing steps remained approximately 45,000 mm/s² for all three nozzle sizes. Although the achievable printhead speed varied slightly between configurations, the acceleration threshold remained effectively constant.

These results indicate that increasing extrusion load up to a 1.0 mm high-flow nozzle does not significantly reduce the maximum achievable acceleration of the disclosed implementations. The data suggest that the differential belt architecture effectively distributes torque such that extrusion demands do not materially compromise translational performance within the tested range.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A method for controlling an additive manufacturing system having an extrusion module movable relative to a frame, the system including a plurality of stationary motors that jointly control translation and extrusion through a differential belt mechanism, the method comprising:
receiving a motion command, wherein the motion command specifies a commanded translational displacement of the extrusion module and a commanded extrusion displacement of extrudent;
computing, based on a differential kinematic transformation, a plurality of motor actuation values corresponding to the commanded translational displacement and the commanded extrusion displacement, each motor actuation value being a function of both commanded displacements;
driving the plurality of stationary motors according to the computed motor actuation values;
translating the extrusion module along an axis in response to a differential component of motion generated by the stationary motors; and
extruding or retracting extrudent in response to a rotational component of motion generated by the stationary motors.

2. The method of claim 1, wherein the motion command comprises a digital control instruction specifying at least one of position, velocity, or displacement of the extrusion module along a defined axis relative to the frame.

3. The method of claim 1, wherein the commanded extrusion displacement comprises a specified volumetric or linear extrudent feed amount corresponding to a desired material deposition or retraction.

4. The method of claim 1, wherein the differential kinematic transformation comprises computing motor actuation values as linear combinations of the commanded translational displacement and commanded extrusion displacement.

5. The method of claim 1, wherein driving the plurality of stationary motors comprises generating synchronized motor control signals that cause the motors to rotate at respective speeds and directions determined by the computed motor actuation values.

6. The method of claim 1, wherein translating the extrusion module comprises generating differential linear motion in a plurality of belts engaging an extrusion pulley such that net lateral force applied by the belts displaces the extrusion module along the axis.

7. The method of claim 6, wherein extruding or retracting extrudent comprises generating coordinated belt motion that applies net torque to the extrusion pulley, thereby rotating an extrusion shaft that advances or retracts extrudent.

8. A system comprising:
an additive manufacturing system having an extrusion module movable relative to a frame, the system including a plurality of stationary motors that jointly control translation and extrusion through a differential belt mechanism;
a processor; and
a memory in communication with the processor, the memory comprising executable instructions that, when executed by the processor, cause the system to perform functions of:
receiving a motion command, wherein the motion command specifies a commanded translational displacement of the extrusion module and a commanded extrusion displacement of extrudent;
computing, based on a differential kinematic transformation, a plurality of motor actuation values corresponding to the commanded translational displacement and the commanded extrusion displacement, each motor actuation value being a function of both commanded displacements;
driving the plurality of stationary motors according to the computed motor actuation values;
translating the extrusion module along an axis in response to a differential component of motion generated by the stationary motors; and
extruding or retracting extrudent in response to a rotational component of motion generated by the stationary motors.

9. The system of claim 8, wherein the motion command comprises a digital control instruction specifying at least one of position, velocity, or displacement of the extrusion module along a defined axis relative to the frame.

10. The system of claim 8, wherein the commanded extrusion displacement comprises a specified volumetric or linear extrudent feed amount corresponding to a desired material deposition or retraction.

11. The system of claim 8, wherein the differential kinematic transformation comprises computing motor actuation values as linear combinations of the commanded translational displacement and commanded extrusion displacement.

12. The system of claim 8, wherein driving the plurality of stationary motors comprises generating synchronized motor control signals that cause the motors to rotate at respective speeds and directions determined by the computed motor actuation values.

13. The system of claim 8, wherein translating the extrusion module comprises generating differential linear motion in a plurality of belts engaging an extrusion pulley such that net lateral force applied by the belts displaces the extrusion module along the axis.

14. The system of claim 13, wherein extruding or retracting extrudent comprises generating coordinated belt motion that applies net torque to the extrusion pulley, thereby rotating an extrusion shaft that advances or retracts extrudent.

15. A non-transitory computer readable medium on which are stored instructions that when executed cause a programmable device to:
receive a motion command, wherein the motion command specifies a commanded translational displacement of an extrusion module and a commanded extrusion displacement of extrudent;
compute, based on a differential kinematic transformation, a plurality of motor actuation values corresponding to the commanded translational displacement and the commanded extrusion displacement, each motor actuation value being a function of both commanded displacements;
drive a plurality of stationary motors according to the computed motor actuation values;
translate the extrusion module along an axis in response to a differential component of motion generated by the stationary motors; and
extrude or retract extrudent in response to a rotational component of motion generated by the stationary motors.

16. The non-transitory computer readable medium of claim 15, wherein the motion command comprises a digital control instruction specifying at least one of position, velocity, or displacement of the extrusion module along a defined axis relative to a frame.

17. The non-transitory computer readable medium of claim 15, wherein the commanded extrusion displacement comprises a specified volumetric or linear extrudent feed amount corresponding to a desired material deposition or retraction.

18. The non-transitory computer readable medium of claim 15, wherein the differential kinematic transformation comprises computing motor actuation values as linear combinations of the commanded translational displacement and commanded extrusion displacement.

19. The non-transitory computer readable medium of claim 15, wherein driving the plurality of stationary motors comprises generating synchronized motor control signals that cause the motors to rotate at respective speeds and directions determined by the computed motor actuation values.

20. The non-transitory computer readable medium of claim 15, wherein translating the extrusion module comprises generating differential linear motion in a plurality of belts engaging an extrusion pulley such that net lateral force applied by the belts displaces the extrusion module along the axis.
